(19) United States
(12) Patent Application Publication
(10) Pub. No.: US 2008/0281904 A1
(43) Pub. Date: Nov. 13, 2008

(54) Associating service listings with open source projects

(75) Inventors: Christopher L. Conrad, Fremont, CA (US); Christopher James Clarke, Milpitas, CA (US); Michael K. Rudolph, Belmont, CA (US)

Correspondence Address: COURTNEY STANIFORD & GREGORY LLP, P.O. BOX 9686, SAN JOSE, CA, 95157, US

(73) Assignee: VA Software Corporation

(21) Appl. No.: 11/801,881

(22) Filed: May 11, 2007

(51) Int. Cl. G06F 17/30; G06F 15/16; G06Q 10/00

(52) U.S. Cl. 709/203; 705/8; 707/3; 707/E17.108

(57) ABSTRACT

Embodiments of a service listing system for open source software projects are described. A plurality of available open source projects are stored in a centralized or distributed database system. Each open source project comprises one or more software programs. Third party support and maintenance services may be provided by third parties service providers. The service listing system associates one or more service listings from service providers with appropriate open source projects. The service listing includes contact information for the service provider, and a schedule of provided services and products, and fees, if applicable. Service listings can be associated with projects based on a specific identification of projects or a definition of categories or types of projects. The system includes an integrated search engine that allows project users to find services based on specific projects or specific services that are available. A rating and certification system allows users to rate service providers and provide feedback that can be used by other potential users of the service provider.

### FIELD

Embodiments of the invention relate generally to product distribution systems, and more specifically, to providing service listings with associated products.

### BACKGROUND

The advent of global computer network systems, such as the Internet, has greatly increased the distribution channels of many products and services. Products and services can now easily be bought and sold across many different markets without much regard for source or territoriality. Many products and services require some level of support for users to effectively use the product or service, either through help with installation issues, quality control problems, revisions and updates, installation help, use instructions, and so on. Whereas traditional product and distribution systems often provide convenient options for the provision of support services through factory or local technical support and so on, products and services available online are not as easily associated with support services. In such cases, support may be strictly limited to factory or manufacturer warranties, or through costly extra service and support contracts.

An example of a particular type of product that is widely available online is open source software. Open source software generally refers to software code that is available or distributed in human-readable form, e.g., as source code, as opposed to software code that is only available or distributed in compiled or binary form. It is generally distributed for free and allows users to create user-generated software content through collaboration or continuous individual development. Because open source software is publicly available, virtually anyone can copy, modify, or redistribute the source code. The class of users and their relative expertise and competence with regard to open source software, and indeed any software product, can vary widely from experts to novices. Moreover, because the products are free and often distributed for further development, no warranties are provided, quality control requirements are sometimes lax, and products may be in widely different states of readiness for use. Consequently, the provision of technical support and service for users is quite important in the open source community. For each of the many different programs, languages, modules, and so on that are available, many different service providers may be available to help users install, use, develop, adapt/port, or integrate the software. However, unlike closed source products, in which support contacts are typically directly linked with the product, service listings and technical support contacts for open source products are often much less formal. In these instances, users must conduct their own investigation to find suitable support, which can take a great deal of time and effort, and may not yield a satisfactory result. What is needed, therefore, is a system that associates available service listings with open source products and projects in a manner that allows users to easily view qualified service listings associated with particular open source projects. What is further needed is a system that allows users to rank service providers and view listings from certified open source service providers.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a computer network system that implements embodiments of a service listing association system;

FIG. 2 illustrates the class of users in relation to the open source projects and service listings, under an embodiment.

FIG. 3 is a flowchart that illustrates a method of associating a service listing with one or more open source projects, according to an embodiment;

FIG. 4 is a table that lists the fields stored by the projects module, under an embodiment.

FIG. 5 is a table that lists the fields stored by the service listing module, under an embodiment.

FIG. 6 is a block diagram that illustrates a service listing system including an integrated search engine, under an embodiment.

FIG. 7 is a block diagram that illustrates the interaction between the search engine and a database storing project listings and service listings, under an embodiment.

FIG. 8 is a flowchart that illustrates a seller to define and post service listings to the system, according to an embodiment.

FIG. 9 illustrates a service listing definition page displayed to a seller under an embodiment in which the seller does specify a particular project.

FIG. 10 illustrates a service listing definition page displayed to a seller under an embodiment in which the seller does not specify a particular project.

FIG. 11 illustrates a service listing description page displayed to a seller, under an embodiment.

FIG. 12 illustrates a posted service listing page that is displayed in response to a user selection of a link on a project listing page, under an embodiment in which a particular project is selected.

FIG. 13 illustrates a posted service listing page that is displayed in response to a user selection of a link on a project listing page, under an embodiment in which a specialization is selected.

FIG. 14 illustrates several different paths through which a buyer can find services associated with projects, under an embodiment.

FIG. 15 illustrates an example project listing display page including links to associated service listings for corresponding projects.

FIG. 16 is an example web page allowing a buyer to find a service directly through the service listing system.

FIG. 17 is an example web page showing menu items associated with a service search function, under an embodiment.

FIG. 18 is a listing of a sample set of project categories displayed through a user interface.

FIG. 19 is a web page allowing a buyer to enter an advanced project search, under an embodiment.

FIG. 20 is an example web page of returned search results for an example service listing search, under an embodiment.

### DETAILED DESCRIPTION

Embodiments of a service listing system for open source software projects are described. A plurality of available open source projects are stored in a centralized or distributed database system. Each open source project comprises one or more software programs. Third party support and maintenance services may be provided by third parties who provide services to users of the open source project for a fee. The service listing system associates one or more service listings from service providers with appropriate open source projects. The service listing includes contact information for the service provider, and a schedule of provided services and products, and fees, if applicable. Service listings can be associated with projects based on a specific identification of projects or a definition of categories or types of projects. The system includes an integrated search engine that allows project users to find services based on specific projects or specific services that are available. A rating and certification system allows users and manufacturers to rate service providers and provide feedback that can be referenced by other potential users of the service provider.

For purposes of the following description, the term “open source” refers generally to software code that is available or distributed in human-readable form, e.g., as source code, as opposed to compiled or binary code. The term “Open Source” refers specifically to open source software that is distributed in accordance with the principles and practices of the Open Source Initiative (OSI), which is a non-profit corporation that maintains an Open Source Definition and provide OS certification to maintain the integrity of Open Source products.

The term “open source project” refers to a program or set of programs that embodies a software product, and may be used interchangeably with “open source product” or “open source program.” Many different types of open source projects are currently available and are stored and/or distributed by potentially many different distributors. Common open source projects that are currently available on the Internet include search engines, project and contact management tools, operating systems, media playback programs, database programs, mail and news servers, content management systems, virtual machines, compilers, debuggers, software libraries and toolkits, and many others.

Open source programs are typically provided for free to users in the form of source code and executable code. Such code is often used by users as is or for integration into the user's own products, or for further development. As such, support for the programs from the manufacturer and/or distributor may be limited. Technical support, however, is often also available from third party users who have particular expertise and may be interested in selling their services to users. Thus, each open source project or type (category) of open source project may have one or more parties who are available to provide any type of technical support for the project. Such technical support may be provided in any form, such as telephone or on-site help, instructions, supplemental programs, bug fixes, patches, development aids, support and maintenance contracts, and the like. Embodiments of a system and method are directed to processes that efficiently and effectively associate or link open source projects to available service providers and support products in a comprehensive open source repository and distribution system.

Aspects of the one or more embodiments described herein may be implemented on one or more computers executing software instructions. The computers may be networked in a client-server arrangement or similar distributed computer network.

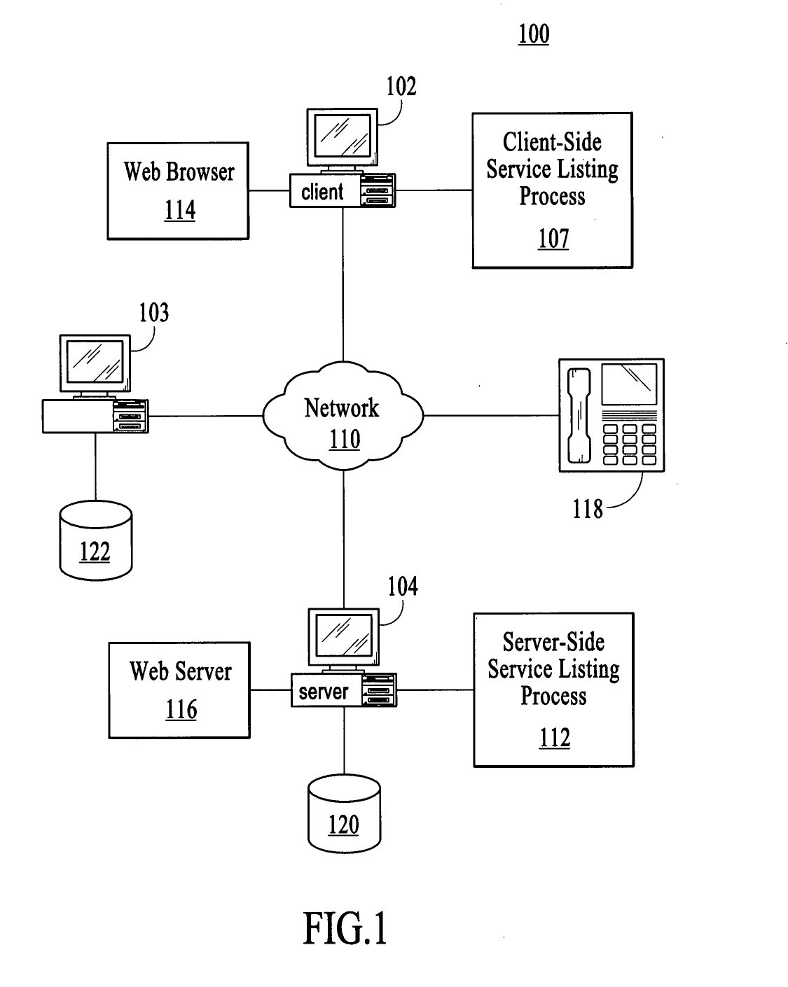

FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server-side service listing process 112. Client versions of this process 107 may also be executed on the client computers. The service listing process may represent one or more executable program modules that are stored within network server 104 and executed locally within the server. Alternatively, however, it may be stored on a remote storage or processing device coupled to server 104 or network 110 and accessed by server 104 to be locally executed. In a further alternative embodiment, the service listing process 112 may be implemented in a plurality of different program modules, each of which may be executed by two or more distributed server computers coupled to each other, or to network 110 separately. As a system that integrates the server and client computers and server listing process 112 (and, optionally, client-side process 107) system 100 may be referred to as a server listing system.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP).

In one embodiment, the server computer 104 has access to a wide variety of open source projects that are available from any number of providers or manufacturers. Each project comprises one or more programs, components, or objects, which may be collectively referred to as “products”. Typically these products are accessed through a variety of networks and stored in databases maintained by the server 104. Alternatively, these products may be consolidated and stored in a single (or virtually single) database that is accessible to the server 104, such as on a data store 120 or data store 122 maintained by a separate server 103. In this manner, data for any of the open source projects, products, and/or services may be provided by a data store 120 closely or loosely coupled to any of the server 104 and/or client 102. In one embodiment, the client computer may execute a client-side service listing process 107 to interact with the server-side service listing process 112. A separate supplemental server or content provider 103 may provide some of the data that is included in the product offering and service listing process. The supplemental server may be operated by a third party service provider who sells or provides services related to any of the open source projects distributed through system 100. These services may be provided in any form of product, data or information that may be locally stored on a data store, such as data store 122. Alternatively, the supplemental server 103 or other servers, not shown, may be used by other entities such as manufacturers or developers of the open source products.

The client computer 102 may be a workstation computer or it may be a computing device such as a notebook computer, personal digital assistant, or the like. The client computer may also be embodied within a mobile communication device 118, game console, media playback unit, or similar computing device that provides access to the Internet network 110 and a sufficient degree of user input and processing capability to execute or access the web browser 114 and the optional client-side service listing process 107. The client computers 102 and 118 may be coupled to the server computer 104 over a wired connection, a wireless connection or any combination thereof.

In one embodiment, a plurality of open source projects are stored in a data store of system 100. The data store may be a centralized data store, such as data store 120 coupled to server computer 104, or it may be a distributed data store or remotely coupled data store, such as data store 122 coupled to supplemental server 103. The storage mechanism, either alone or together with a distribution mechanism may be referred to as a “repository” of open source projects. The client computer is operated by a user of open source projects. The user accesses the available open source projects through a web browser interface 114 to the server computer 104. The service listing process 112 associates a number of available service listings available from any third party service provider or product manufacturer with each appropriate open source project.

In one embodiment, a service listing refers to a description provided by a service provider that lists the service providers contact information, services provided, availability, terms and conditions, restrictions, endorsements, schedule of fees, and any other relevant information regarding the provision of services to the user related to the open source project. A user is a person who uses or is involved with the use, creation, modification or other manipulation of an open source project.

In one embodiment, the service listing process 112 includes a user and project registration system that defines known users and projects and restricts access and use on a role-based or privilege basis. In general, only defined projects and products may be stored in the repository and distributed through the system, and only registered users and service providers may use the system. A user is a person who is registered with a repository that stores or provides access to open source projects. Registration allows a user to be identified within the system and may grant certain privileges under role-based definitions, as distinct from a visitor who may access the open source repository system without registering or logging in. For purposes of discussion, the term “buyer” refers to a user who buys services through services listings and a “seller” (or “service provider”) refers to a user who sells services through service listings. In general, a service can be any type of service, such as technical support services, training, bug fixes, and the like, and can be information that is provided either verbally, in writing, or in the form of product.

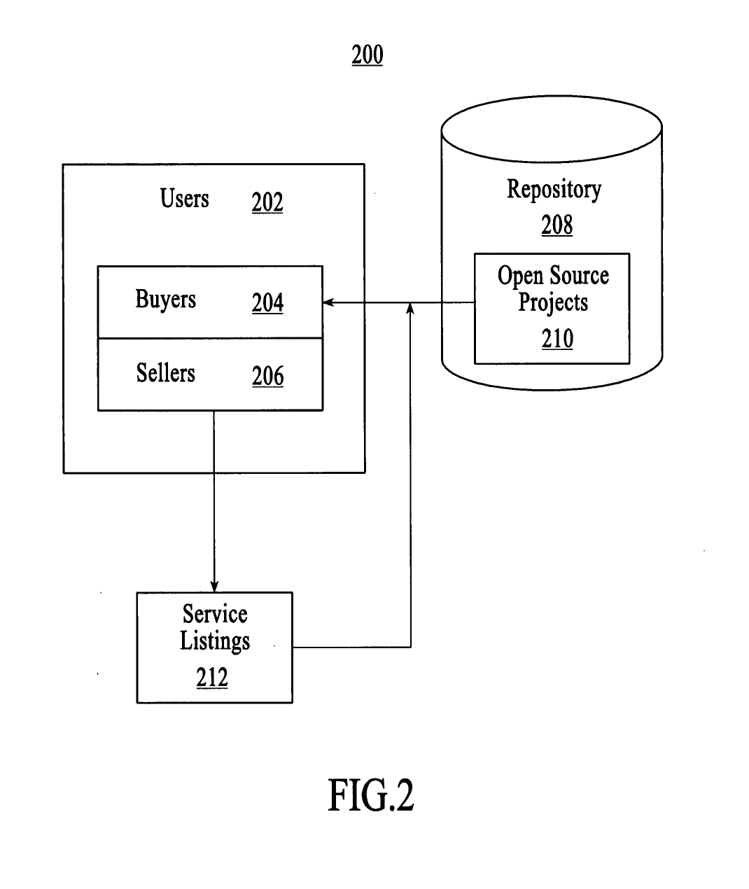

FIG. 2 illustrates the class of users in relation to the open source projects and service listings, under an embodiment. As shown in system 200, the users 202 comprise buyers 204 and sellers or service providers 206. Open source projects 210 are stored within a repository 208 and are accessed for use or manipulation by buyers 204. The repository 208 can represent a centralized data store that is configured to store a large plurality (e.g., tens of thousands) of open source projects, or it can represent a distributed data store, or even a portal that allows user access to open source projects that may be stored anywhere on a network. The open source projects comprise products that may be made by another class of users, not shown, that are referred to as “manufacturers.” The sellers 206 provide services that are related to at least some of the open source projects 210. The sellers create and maintain service listings 212 that describe their particular services and the terms and conditions of the service. The service listing process 112 associates the service listings 212 with the corresponding and appropriate open source projects 210 for display to the buyers 204. The sellers may be independent third parties or they may be manufacturers, agents, or associates of a manufacturer.

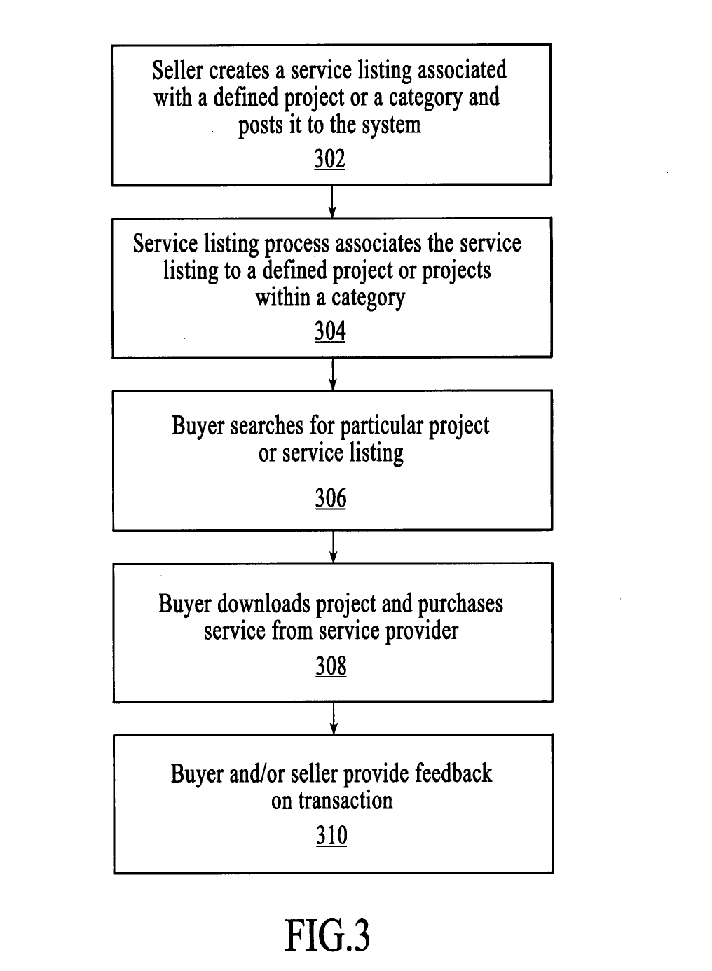

The service listing system 100 provides a networking environment that allows sellers to list services that are associated with specific open source projects that are accessible to users of the system. Buyers can then access the project and view and purchase available services related to that project. FIG. 3 is a flowchart that illustrates an overall method of associating a service listing with one or more open source projects and providing access to a buyer, according to an embodiment. As shown in process 300, a seller creates a service listing associated with a defined project or category and posts it to the system, block 302. The service listing process 112 associates the service listing to a defined project or projects within a category. In one embodiment, this association is embodied by a link or indicator that is displayed on or with a project listing through the user interface of the buyer. This link easily allows a user to find services associated with the project and eliminates the need for the user to independently and manually search for services, which is a problem that is pervasive in present open source distribution systems.

The defined projects comprise projects that are stored in a project repository in system 100, block 304. The service listing process returns the appropriate project to the buyer in response to a search by the buyer for a particular project, block 306. If the buyer searches for a particular service listing directly, the process returns the appropriate service listing to the buyer. The buyer then downloads or otherwise accesses the project and purchases the desired associated service from the seller. Upon purchase, the buyer enters a binding contract with the seller to utilize the service. In one embodiment, the service listing process provides a feedback mechanism that allows the buyer and/or seller to rank or rate the service part of the transaction, block 310. The flowchart of FIG. 3 outlines the general steps of a service listing method, and specific functional details associated with each process block illustrated in FIG. 3 will be described in greater detail below.

As shown in FIG. 2, the open source projects are stored in a repository 208, which may be a central data store, or a distributed data store comprising a plurality of data stores on a network. Each project may be indexed by a project listing that provides a summary description of the project as well as other relevant data or metadata about the project. If a buyer knows the network location of a particular project of interest, he may download it directly from the appropriate data store location. Alternatively, however, a buyer accesses the open source projects by performing a search over the network. In order to facilitate locating and downloading open source projects, the service listing process 112 includes a projects module that stores defined fields associated with each project.

In one embodiment, the repository 208 represents a data store that stores open source software modules and any associated components for open source projects. Such modules are identified and stored in specific addressable locations so that they may be searched for and retrieved by users utilizing search and access tools. The repository may also include components that transmit or distribute these modules to users upon request.

The repository may further include one or more source code management systems that facilitate the management and distribution of the open source modules. For example, the open source programs may be accessible or distributed as source code or as compiled code or executable code. The repository can also include processes that capture data about the open source projects and compile statistical data that may be used by users. In general, the open source software modules include the software (source and object code) for the programs of the project as well as any metadata for the project, including descriptions and so on.

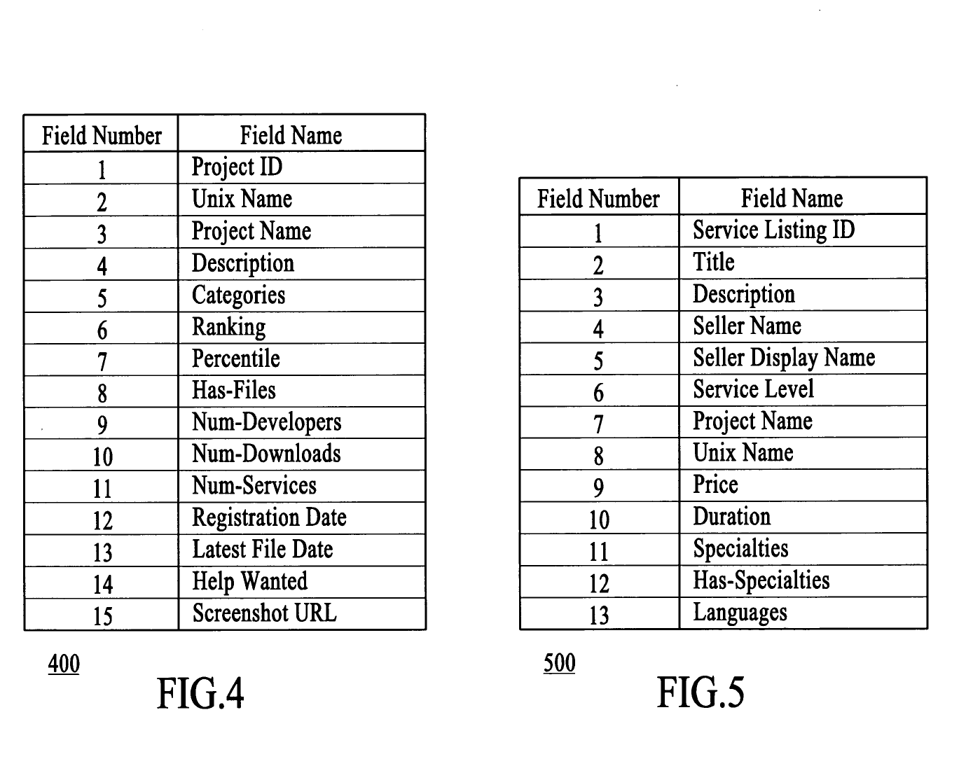

FIG. 4 is a table that lists the fields stored by the projects module, under an embodiment. As shown in table 400, the first field contains the project identifier, which can be an alphanumeric string of any appropriate length that uniquely identifies the open source project within the database. Each project must have its own unique id to be searchable. The second field contains the Unix name for the project, which is a short name or mnemonic for the project. The third field is the project name, which is a descriptive name for the project, and the fourth field contains a textual description of the project. The fifth field lists the categories for the project, which are the categories in a cataloging system that the project is associated with. In one embodiment, the repository system defines a number (e.g., on the order of one hundred) general categories that a project may fall under, such as operating system project, network, game, programming language, and so on. Each broad category may have several sub-categories, such as within networking there may be wireless networking, and then Bluetooth networks, and so on. Each category defines tags that are associated with each project.

In table 400, the sixth field indicates the project's ranking among other projects within the system, and can be used as part of a statistics system. The seventh field indicates the project's activity percentile, which can also be used as part of the statistics system. The eighth field, labeled “has_files” indicates whether or not the project has files available for download. Then ninth field stores the number of developers associated with a project, and the tenth field stores the number of times a project's file releases have been downloaded. The eleventh field stores the number of services associated with a project. Field 12 indicates the registration date of the project, which is the date that the project was logged into or registered in the system, and field 13 indicates the date of the most recent file release. Field 14, labeled “help_wanted” indicates whether or not the project is asking for development help. The fifteenth field stores uniform resource locators (URLs) for websites where screenshots for the project are stored. The fields illustrated in FIG. 4 are illustrative of the many different fields that can be used. The size and format of each field can be tailored to the requirements of the system.

As with the project listings, each service is indexed by a service listing that provides a summary description of the service as well as other relevant data or metadata about the service. If a buyer has contact information for a particular service provider, he may make contact directly. More typically, however, a buyer accesses the services by access to particular open source projects or a by performing a search over the network. In order to facilitate the locating and accessing of support services for open source projects, the service listing process 112 includes a service listing module that stores defined fields associated with each service listing and facilitates the search and linking (association) processes. Data for the services may be stored in a data store maintained by the service provider, e.g., server 103 and data store 122 of FIG. 1, however, the service listings are usually stored within the repository once they are created and posted to the system 100.

FIG. 5 is a table that lists the fields stored by the service listing module, under an embodiment. As shown in table 500, the first field contains the service listing identifier, which can be an alphanumeric string of any appropriate length that uniquely identifies the service listing within the system. Each service listing must have its own unique ID to be searchable. The second field contains the title of the service listing, and the third field contains a textual description of the service provided by the seller. Field 4 stores the seller's name, which can be a short pseudonym or nickname for the user. Field 5 stores the display name of the seller, which can be the actual name of the seller or a descriptive user name. The sixth field indicates the service level of the listing. The seventh field indicates the project name for which the service listing is associated. A valid project name corresponds to a matching project name in the projects module. In general, each service listing is associated with a single project. In an alternative embodiment, a service listing may be associated with multiple projects. In this case, the project name field allows the seller to associate his service listing with a number of different projects. Field 8 stores the project listing's Unix name, which corresponds to the Unix name in the projects module. The ninth field indicates the price or fee for the service, and the tenth field indicates the duration or time period terms associated with the service. Field 11 allows the seller to describe any specialties with regard to any of the projects, and field 12 indicates whether or not any such specialties where specified by the seller. The use of the specialties fields 11 and 12 allow the seller to associate his service listing with a category of projects, as opposed to an individual project or projects. Finally, the thirteenth field lists any languages that the seller is able to use. As with FIG. 4, the fields illustrated in FIG. 5 are illustrative of the many different fields that can be used for the service listings, and the size and format of each field can be tailored to the requirements of the system.

### Integrated Search Engine

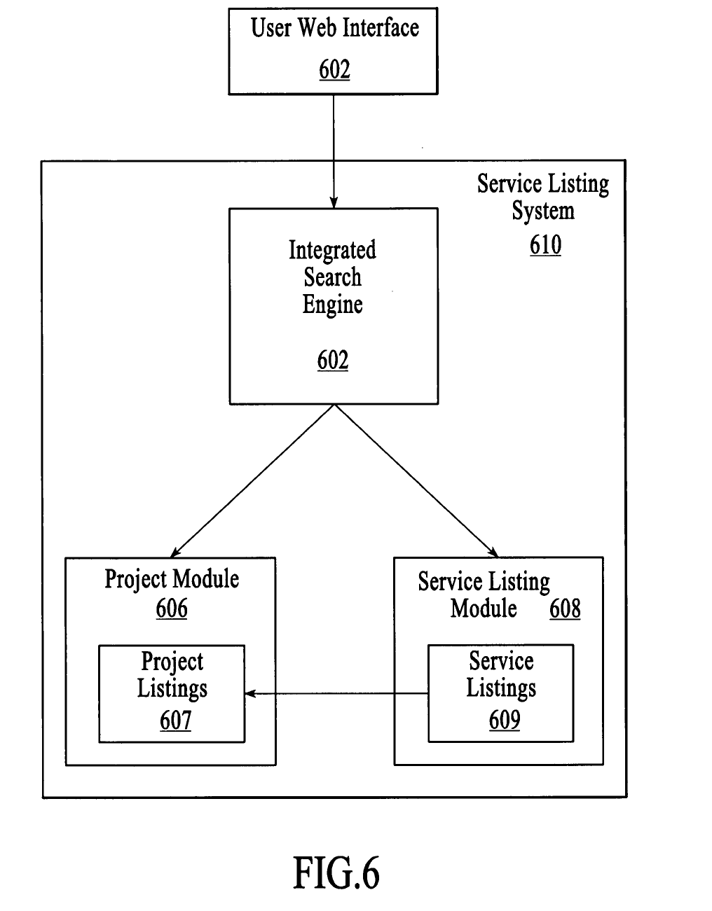

In one embodiment, the project listings and service listings are indexed in respective databases to enable searching by the user. The service listing system includes an integrated search engine that allows for a search using the project and service listing indices. FIG. 6 is a block diagram that illustrates a service listing system including an integrated search engine, under an embodiment. The search engine comprises an information retrieval component that allows for full text searching on indexed data. In one embodiment, the search engine component comprises a scalable, high-performance indexing search engine that provides ranked searching to provide best results first in response to particular search terms. The search engine supports a variety of query types including phrase queries, wildcard queries, proximity queries, range queries, and so on. The search engine supports searches based on pre-defined fields (e.g., name, field of expertise, and so on), and sorting by any field. The system operator can define the fields. The search engine also supports multiple-index searching with merged results, and allows for simultaneous update and searching. One possible search engine that may be utilized is a publicly available search engine, such as Apache Lucene. Lucene is an open-source, high-performance, full-featured text search engine library written entirely in Java, and is suitable for any application that requires full-text search, especially cross-platform.

The service listing system 610 includes the project module 606 that stores the project listings 607, and the service listing module 608 that stores the service listings 609. The project listings 607 and service listings 609 are indexed to allow for searching by the search engine 602. A user performs a search through a web interface 602 and searches the indexes to retrieve the relevant data from the data stores that contain the project listings and/or service listings. The integrated search engine 602 provides a powerful and effective mechanism to enable the linking of services to projects based on a single search process executed by the user and prevents the need for performing separate searches outside the system.

The service listing system can also contain other search modules that are accessible by the search engine 602, such as a document manager, file releases, forums, mailing lists, newslists, trackers, and the like.

With regard to sorting, the search engine, by default, provides search results sorted by relevance. Relevance can be calculated using the score of a query for a document that correlates to the cosine-distance or dot-product between document and query vectors in a Vector Space Model (VSM) of information retrieval, or any other similar similarity algorithm. A document whose vector is closer to the query vector in that model is scored higher. The search engine may provide a mechanism that allows them to specify the field used to sort their search results. Sorting by a field other than relevance is equivalent to sorting the result set by a search term found in a result according to the natural alphanumeric sort order. Which search term found in the result that will be used for sorting can be treated as though it were randomly chosen. For example, if a user executed a search and the set of terms in one of the documents in the search results is {dog, jumps}, then either the term dog or the term jumps may be used to sort the search results. It may seem on first glance that this is problematic since sorting by jumps would cause the document to appear among the “j” results instead of the “d” results. However, the result appearing in either the “j” or the “d” results would be incorrect because the original text stored in the index (and, therefore, the text which is displayed to the user) is “The cat jumps over the dog.” The user would rightly expect this to appear among the “t” results since the first letter of the sentence is “T.” Therefore it is necessary for the search engine to sort on a different field (the “shadow” field) than the field that is searched on in order to provide results that the user expects.

The search engine also provides mechanism that is used to sort on a field that is different from the field that is searched on. The search engine requires that each module expose a method named computeSortFieldName(String fieldname). This method is expected to take the name of the field being searched on and returns the name of the field to sort on. Modules generally implement this method by maintaining a mapping between the fields requiring special sorting support and the “shadow” field that is formatted correctly for sorting. For example, the project search module contains this code:

```
@Override
protected String computeSortFieldName(String fieldName) {
    if (fieldName.equals(“name”)) {
        return “name-sort”;
    } else {
        return fieldName;
    }
}
```

The final piece necessary to implement correct sorting behavior is defining what the correct formatting is for the “shadow” field. Previously the sort criterion was defined as “natural alphanumeric sort order.” Natural alphanumeric sort order may require further processing. For example, first, lowercase and uppercase letters are sorted separately, thus “a” will not appear next to “A.” Lowercasing the text and not further tokenizing it before storing it in the index solves this problem. Second, numbers are not treated as numbers but as text. This means that the set of numbers {1, 2, 3, 11, 21, 31} will be sorted as {1, 11, 2, 21, 3, 31}. To solve this issue, the system left zero pads all numbers stored in the index. The number of zeros needed is context specific. In the example above padding to two digits would suffice meaning that the numbers stored in the index would be the set {01, 02, 03, 11, 21, 31}.

In one embodiment, the service listing system employs a caching mechanism to allow the sorting functionality to execute reasonably quickly. In general, the search engine only knows about the terms in the results that match terms in search query. This typically does not provide the necessary amount of information required to sort the results; it would only be sorting against the terms found in the search query, not all of the terms in the index. This issue is resolved by synchronously loading all of the terms in the index into memory when a sort is performed. While loading all of the terms in the index into memory solves the sorting problem, it may create a performance problem at runtime. In systems in which a large amount of data is stored, loading the data into memory can take a significant amount of time. For example, with present computers, smaller index loads can take several seconds, while larger indexes can take upwards of 30 minutes. While waiting for the data to load, search queries can pile up quickly causing the search engine to run out of available threads. Once that occurs, the search engine is effectively offline. To overcome this issue, instead of loading the terms into memory, the search engine performs the same function asynchronously from the searching and sorting process. The search engine handles the caching issues immediately before executing a search query using the following process:

1. Check the “currently running” flag to see if the cache is currently being updated
2. If the cache is currently being updated proceed to 8
3. Check to see if there is a new copy of the cache available to use
4. If there is a new copy of the cache available, replace the old one with the new one
5. Check to see if the cache is out of date
6. If the cache is not out of date proceed to 8
7. Start a new thread executing a FieldCacher and set the “currently running flag” to true

### 8. Execute the Search

A FieldCacher process creates a cache for the module it is associated with. Each module can provide an implementation of FieldCacher and if the module provides an implementation it is used. Because the FieldCacher runs asynchronously it does not affect the currently executing queries. Once it finishes creating the cache, the FieldCacher makes it available so that the next search request that comes by can replace the out of date cache with the newly created one. Finally, the “currently running” flag is set to false.

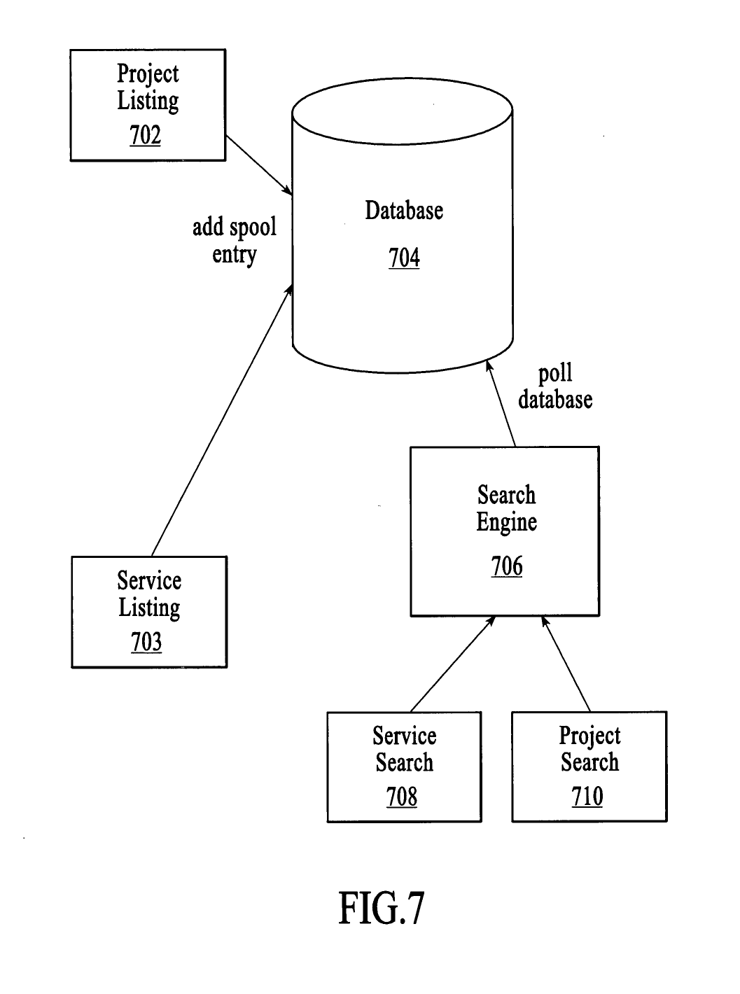

FIG. 7 is a block diagram that illustrates the interaction between the search engine and a database storing project listings and service listings, under an embodiment. Project listings 702 are provided by manufacturers or created by a system administrator of system 100 for access within the repository. Service listings 703 are created and defined by the service providers for access within of the repository. Each service listing creates a spool entry that is stored in a database 704. Database 704 may represent a single data store or a distributed data store within the system. Each project listing 702 may also create a spool entry that is stored in database 704. In one embodiment, a spool entry is an index that has a plurality of different fields describing a characteristic of the associated listing. For example, a spool entry may have the following format:

TYPE-/-ID-/-TIME STAMP-/-MODIFICATION TYPE

The type field indicates the entity type, which for the embodiment of FIG. 7 is either a project listing or service listing, and in other embodiments could be listings for other search modules, such as document manager, file releases, forums, mailing lists, newslists, trackers, and so on. The ID field indicates the unique identifier for each project or source listing, the time stamp field indicates the latest modification time for the listing, and the modification type field indicates the type of modification that was last made to the listing. Modification types may include additions, updates, deletions, corrections and any other similar type of revision. Each field within the spool may be a single or multi-character alphanumeric entry field that encodes a corresponding field entry. For example, there may be eight types of entities, of which a project is “1” and a service is “2”, a large number of IDs (generally corresponding to the total number of listings), a time stamp in standard 24 hour clock and date, or qualitative format, and three or more types of modifications (e.g., add=“1”, update=“2”, delete=“3”, etc.) Thus, an example spool may appear as “1/10/NOW/1” and be interpreted as a project listing of ID 10 that was last modified immediately by an addition of material.

As shown in FIG. 7, the integrated search engine 706 receives service search requests 708 and/or project search requests 710. The search engine polls database 704 periodically, e.g., every 30 seconds to retrieve the latest entries. The time stamp field is used to identify the latest entry. Based on the type field, the process hands the entry to the appropriate module. If the modification is a deletion, the data for the identified listing is deleted. If the modification is an addition, the process retrieves the listing data by making a retrieval request for all information for the identified listing from the database and then inserts the added data to the index. If the modification is an update, then the steps for the deletion and addition are executed together.

In one embodiment, a search operation, e.g. service search 708 or project search 710 is executed over a TCP-IP socket from the user web site to the search engine 706. The search is passed to the appropriate module based on a tag generated by the web interface or the ID within the entry. The module then takes the specific listing data from the database and returns it to the user.

### User Interface

In one embodiment, the service listing process comprises an overall environment that has a repository to allow access to defined open source projects and service listings, as well as a user registration system that allows buyers and sellers to register and use the system by either accessing projects and buying services, or selling services to users of projects. As shown in FIG. 1, the system provides a web-based interface that allows for buyers and sellers to access the system. In a typical implementation both buyers and sellers register with the system to become registered users.

The interaction and process flow, and web interface modules differ depending on whether the user is a seller or buyer. In general, the interface allows a seller to define and post service listings to the system, and it allows a buyer to find projects and associated service listings and to purchase services from a seller.

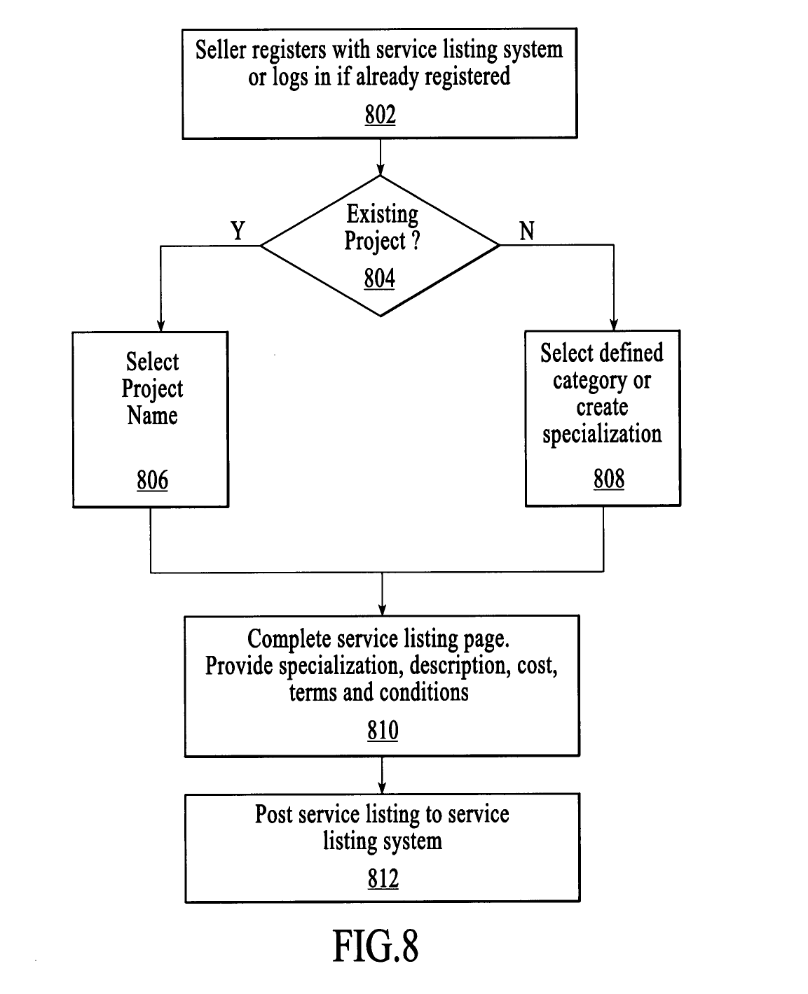

FIG. 8 is a flowchart that illustrates a seller to define and post service listings to the system, according to an embodiment. As a preliminary step, the seller first registers with the service listing system, or logs in if he is already a registered user, block 802. This allows a service listing definition page to be displayed through the user interface on the client computer of the seller. The seller first selects whether the service is for a particular defined project, that is, one that exists within the system and can be identified and downloaded by a buyer, block 804. If the service listing is for a particular project, the buyer then enters or selects the project name from a drop-down menu or similar interface tool, block 806. If the service is not for a defined project, the seller selects a broad category or defines a custom specialization, block 808. Once the seller has selected the particular project or defined the category or specialization with which to associate his service listing, he fills out a service listing page that allows the seller to provide a description of the service and specify terms, conditions, and other relevant parameters associated with the service, block 810. The seller then posts the service listing to the service listing system, block 812. This posting operation causes the service listing process to create a link between the particular project listing and the service listing if the seller selected a particular project name in block 806, or to create a link between the service listing and any or all of the projects within a category or specialization if the seller defined a category or specialization in block 808.

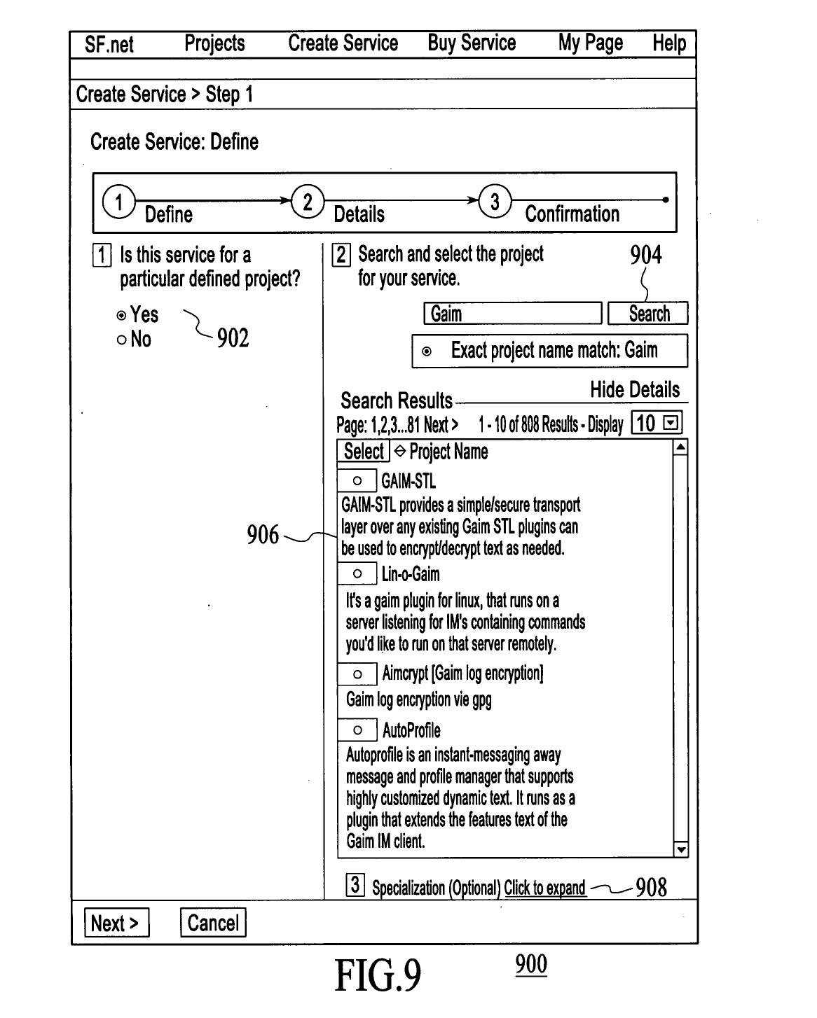

FIG. 9 illustrates a service listing definition page displayed to a seller, under an embodiment. As shown in FIG. 9, page 900 includes a binary selection area 902 that allows the user to select whether or not the service is for a defined project. In the case that a defined project is selected by the seller, as illustrated in the example of FIG. 9, a search field 904 allows the seller to search for projects stored within the repository, alternatively a project name entry field can be provided to allow the seller to type the project name in directly. The search function 904 creates a search result window 906 to be displayed that allows the seller to select the appropriate project name. If the seller wishes to provide information regarding a particular specialization, a text area is available through interface tool 908.

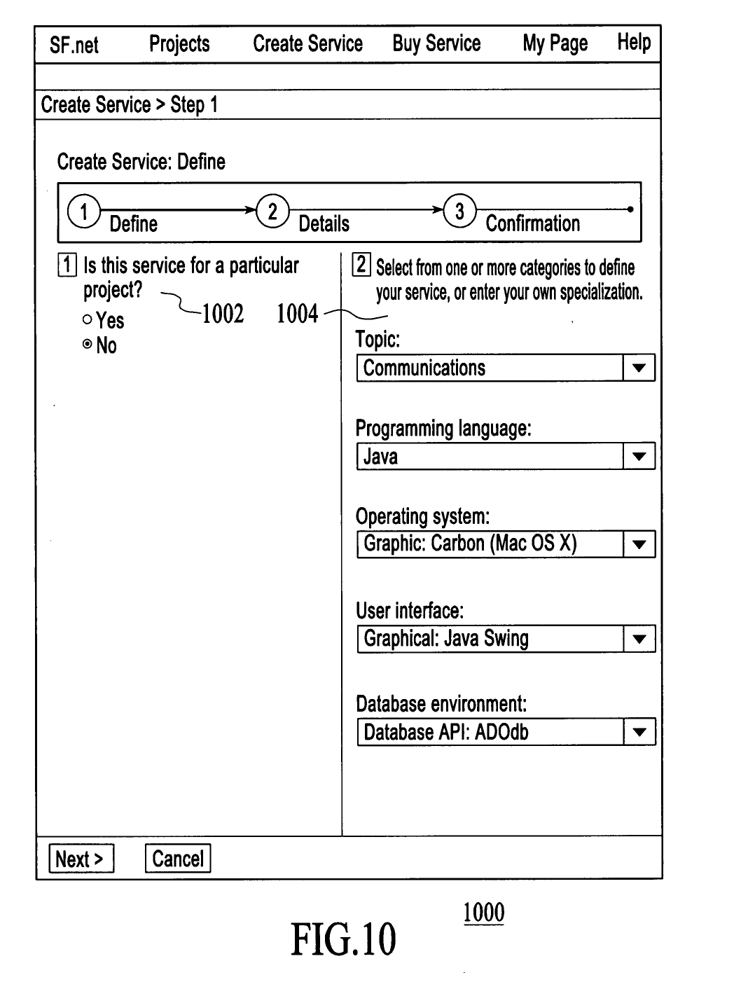

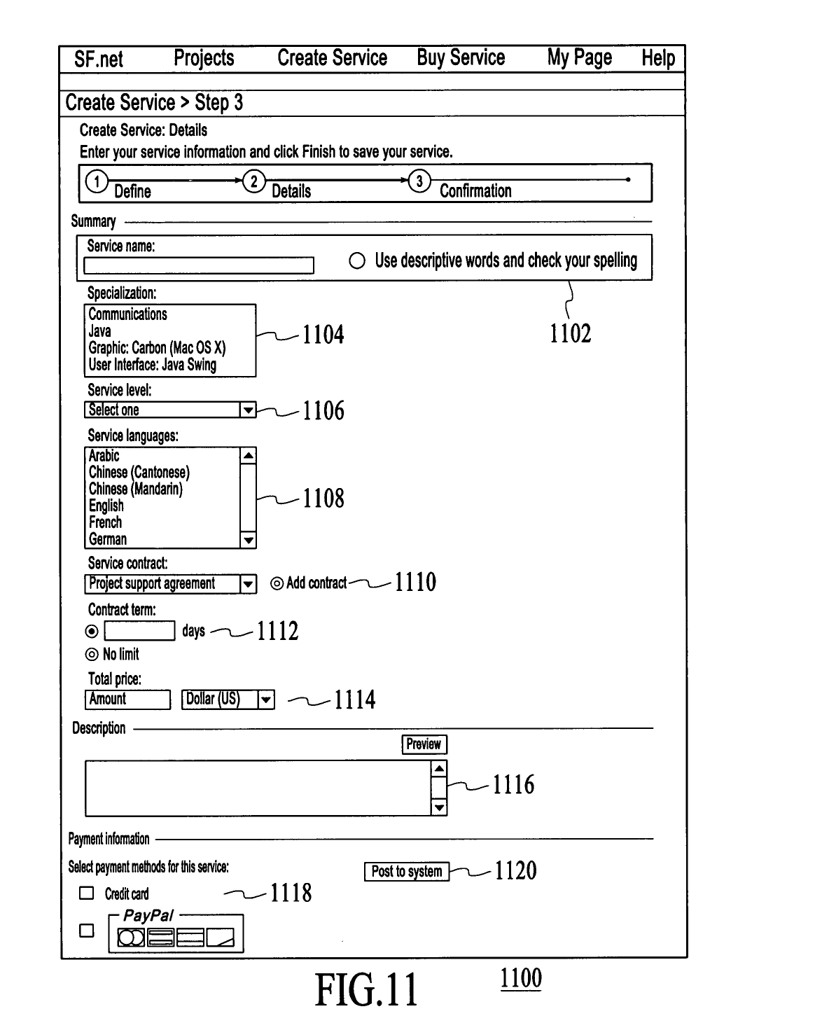

FIG. 10 illustrates a service listing definition page displayed to a seller under an embodiment in which the seller does not specify a particular project. In this case, as illustrated on web page 1000, the seller indicated that the service is not for a particular project. The process then displays a group of selection fields 1004 that allow the seller to specify certain items of information regarding the service. These define the categories of projects or areas of specialization of the seller, and can include software-specific items, such as topic or field of technology, programming languages, operating systems, user interfaces, database environments, and the like.

As shown in block 810 of FIG. 8, once the seller has specified the project name or defined the category or specialization, he then fills out a service listing description page. FIG. 11 illustrates a service listing description page displayed to a seller, under an embodiment. Web page 1100 has an entry field 1102 for entry of a descriptive service name and a field 1104 that allows the seller to specify a specialization either through text entry or selection from a menu of items. The service level can be selected in entry field 1106. Other fields allow entry of other relevant service metadata, such as service languages 1108, type of contract 1110, contract term 1112 and price 1114. A text area 1116 allows the seller to provide a textual description of the service, as well as any other relevant information, such as qualifications, references, and so on. A payment information section 1118 allows the seller to indicate how payment is accepted. Once the service description has been provided, a service listing is created and the user can post it to the system using command box 1120.

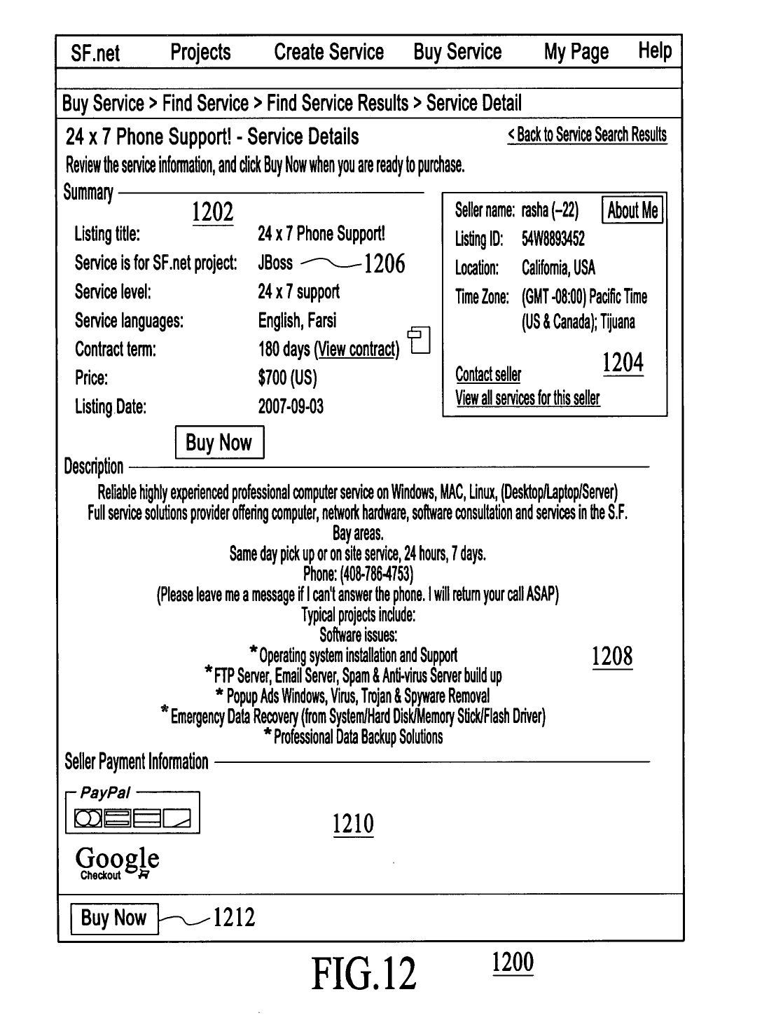

In one embodiment, the information from the service listing description page 1110 is used by the system to create a service listing page. FIG. 12 illustrates a posted service listing page that is displayed in response to a user selection of a link on a project listing page, under an embodiment in which a particular project is selected. As shown on web page 1200, the service listing page contains all of the information provided by the seller in the service listing description page, along with any other information that may be provided or derived from the system. The example web page 1200 includes a summary section 1202 that summarizes the service, as well as contact information for the seller, box 1204 and the description of the services 1208. Most fields of page 1200, such as the description section 1208 are imported directly from corresponding fields of the service listing description page 1100. Page 1200 also includes a payment section that displays payment options 1210 and a buy now command button 1212.

The service listing page of FIG. 12 illustrates a case in which the seller is providing services for a defined project that is store or distributed through the repository. In this case, the service listing process only links the service listing with the identified project. In certain embodiments, a service listing may be linked to two or more identified projects, but each project must be individually identified by the seller.

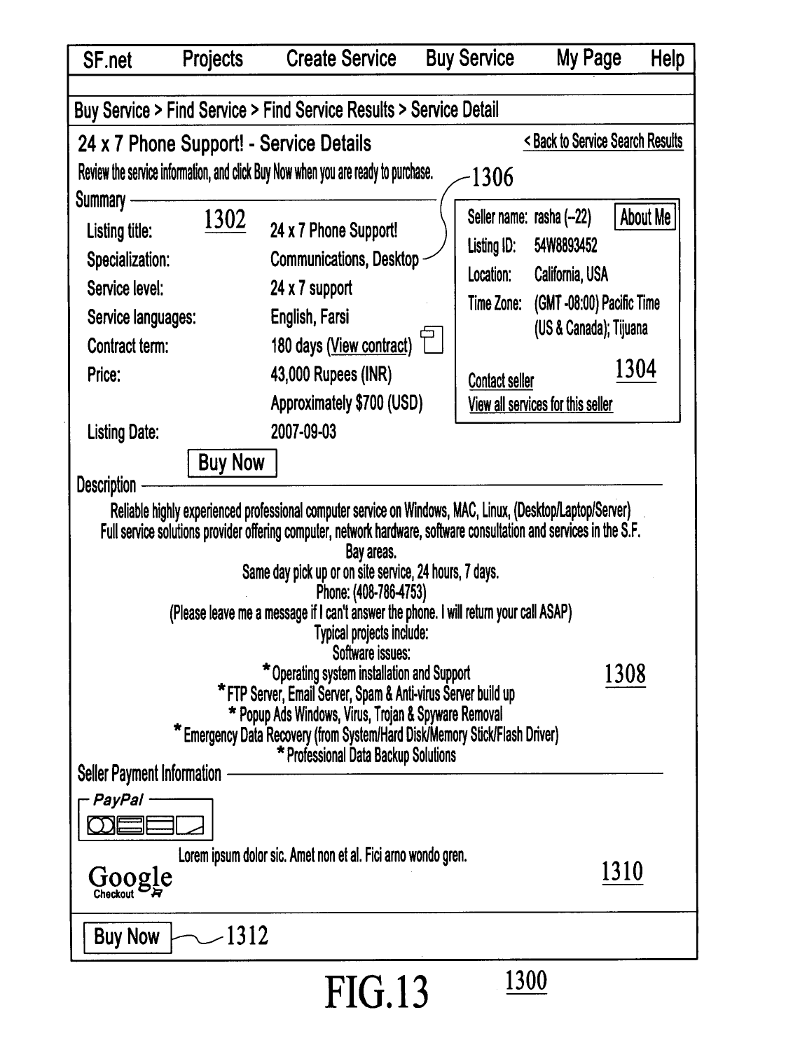

In certain instances, a seller may not have a particular project to support, but rather provides support for categories of projects. In this case, the project listing does not display the actual service, but rather the selected category. FIG. 13 illustrates a posted service listing page that is displayed in response to a user selection of a link on a project listing page, under an embodiment in which a particular specialty is selected. In this case, most display areas of page 1300 are analogous to those of page 1200, however, the project field 1202 is replaced with a specialization field 1306, which lists the categories of specialization indicated by the seller. The service listing process 112 may link this listing with any or all projects within that category or specialization.

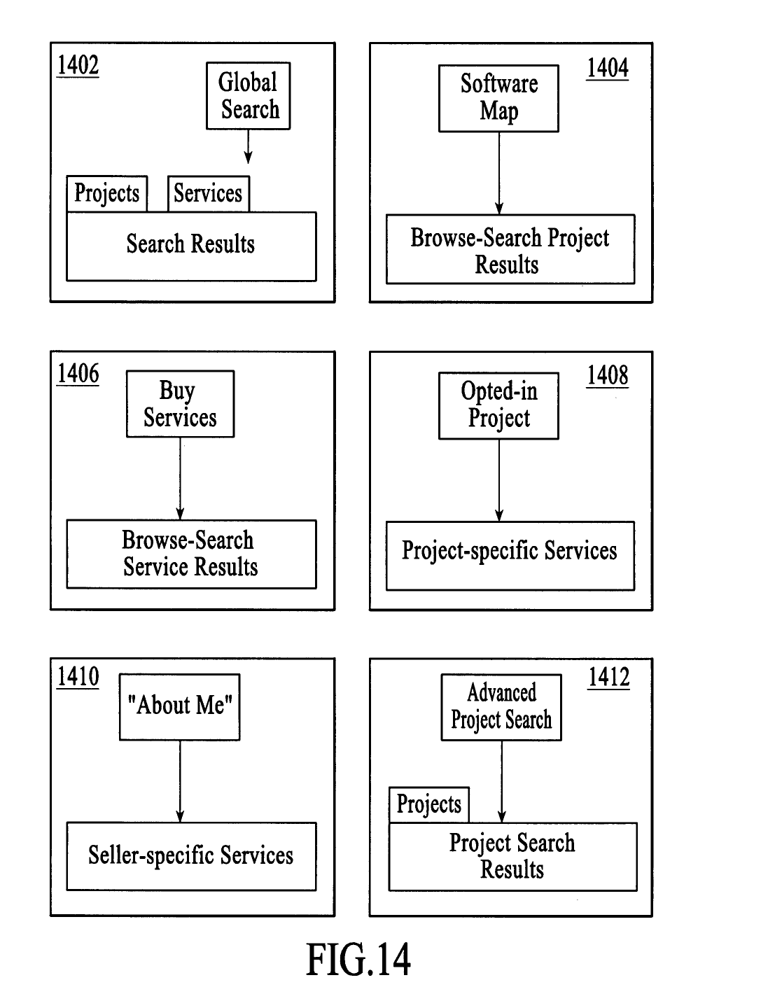

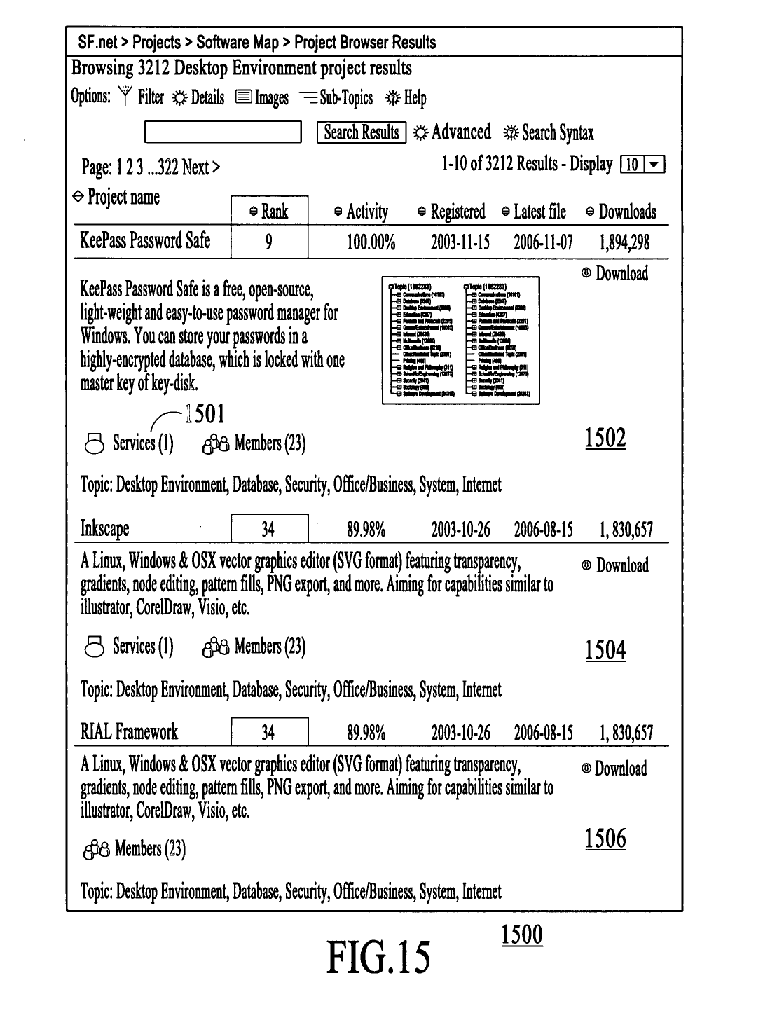

Once the system has stored or provided access to open source projects in the repository and allowed one or more sellers to post service listings, it provides access to the projects and associations to the service listings to the buyer. In one embodiment, the buyer interfaces with the system through a web-based interface. The buyer can search for and select projects within the system as well as related service listings in a variety of different ways. FIG. 14 illustrates several different paths through which a buyer can find services associated with projects, under an embodiment. Under the method of block 1402, the buyer enters a global search through the search engine for either projects and/or services. The search engine then returns search results in a results page that lists all of the responsive projects and/or service listings. The buyer can search for any projects or services, or he can search for projects that have associated service listings. Box 14 of FIG. 14 illustrates a specific instance of the global search method in which the buyer searches specifically for projects that have service listings. In this case, the search engine will not return any projects, unless there is a service listing associated with it. FIG. 15 illustrates an example project listing display page including links to associated service listings for corresponding projects. Example web page 1500 contains three example project listings, KeePass 1502, Inkscape 1504, and Rial Framework 1506. Each project listing contains a summary of the project, relevant information regarding the project and its use, and a download command button that allows the buyer to download the project. Projects that have service listings associated with them also include an icon or indicator 1501 that indicates the presence or number of service listings that are associated with the project. Thus, for the example of FIG. 15, the KeePass project has a single service listing linked to it, and Inkscape has three service listings linked to it. Clicking the service listing icon will cause the associated service listing or service listings to be displayed to the buyer. FIG. 15 illustrates an instance of a search result page returned for a global search rather than an “opted-in project” search, since the Rial project 1506 does not have any service listings linked to it.

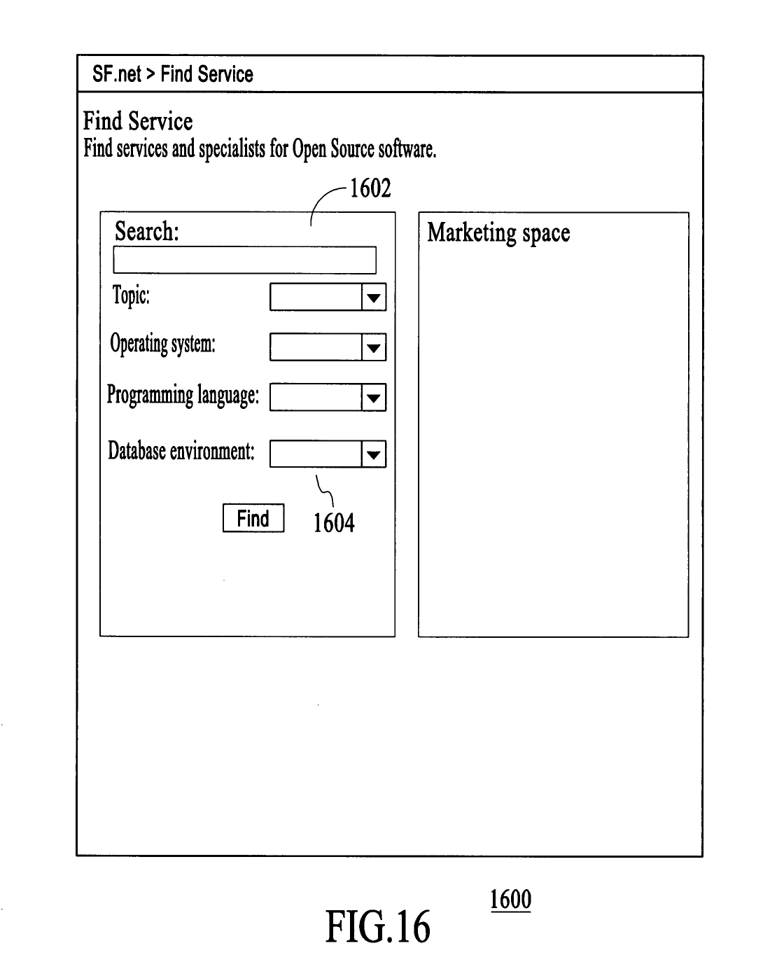

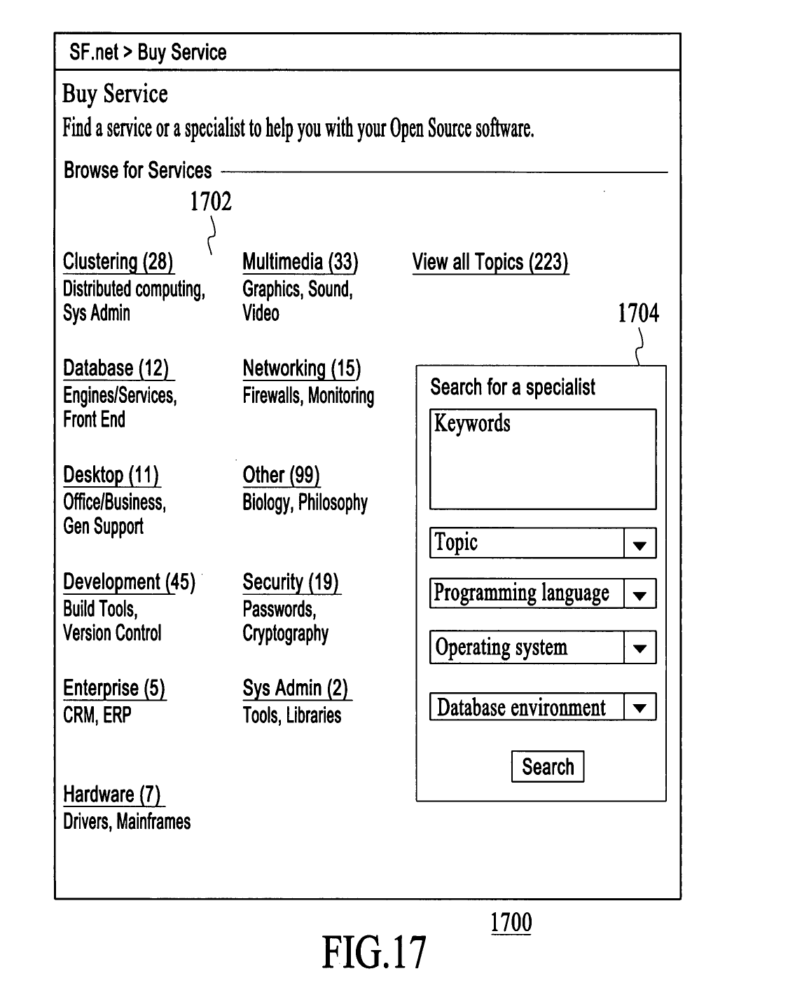

With reference to FIG. 14, a second way in which a buyer may access service listings is shown in block 1406 in which the buyer can search for services directly through the search engine. FIG. 16 is an example web page allowing a buyer to find a service directly through the service listing system. Web page 1600 has a search field 1602 that allows the buyer to specify a seller name or ID for direct service listing searching. Alternatively, the buyer can search for sellers using more general information 1604, such as topic, operating system, programming language, and database environment. The illustrated fields are for example only, and many other metadata fields may also be provided. In one embodiment, the system may provide a menu based service search page. FIG. 17 is an example web page showing menu items associated with a service search function, under this embodiment. As shown on web page 1700, a number of browse menus 1702 are provided for the buyer to investigate and make selections from. These menus are based on categories of projects, but can be based on any other suitable characteristic. For convenience, a standard text based search engine window 1704 may also be provided to allow for direct searches.

As shown in block 1410 of FIG. 14, the system also allows a buyer to search for seller-specific services through an “about me” search. This allows the buyer to specify information about the buyer himself and the search engine finds the best results for matching services based on this information.

In one embodiment, a search for projects and associated services can be performed using a software map or other representation of the projects that are available in the system. Such a method allows the user to find appropriate services through navigation of a software map or hierarchical tree showing all of the project categories.

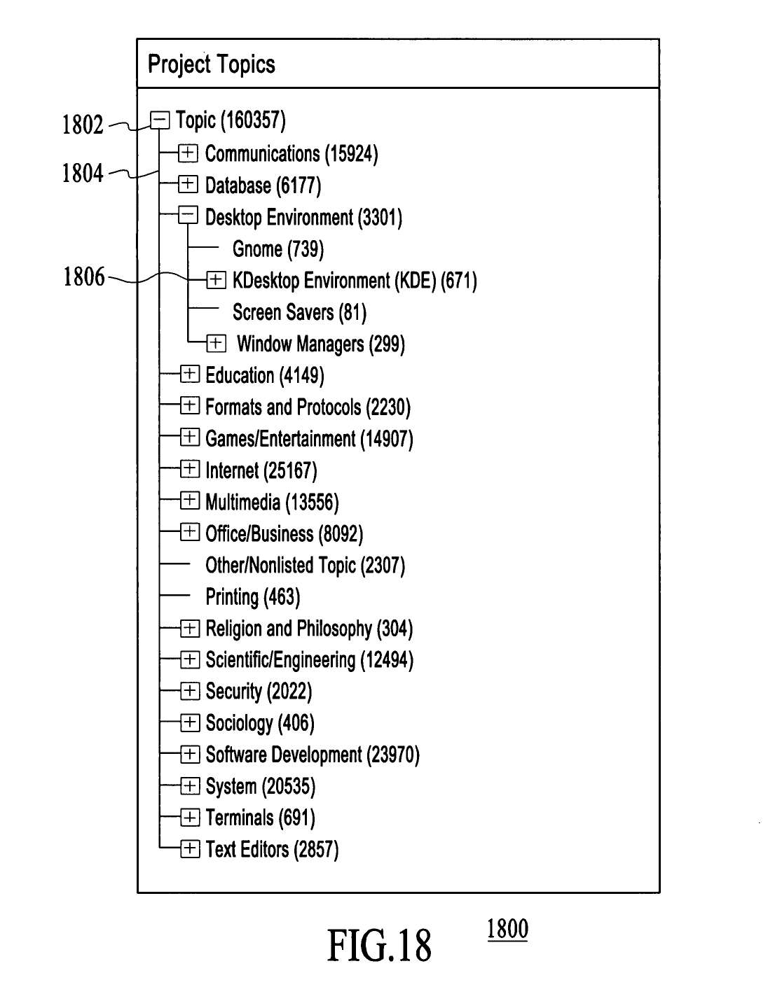

FIG. 18 is a listing of a sample set of project categories displayed through a user interface. In the embodiment of FIG. 18, and number of projects are presented by project topic. The root directory “topic” 1802 shows the total number of projects available in the system (in this case, 160,357). The topics are then organized into a number of different subtopics, such as communications, database, games, security, and so on. Each subtopic, e.g., 1804 can then include further subtopics, e.g., 1806. In this manner, a buyer can “drill-down” the list until he finds a particular project or projects of interest.

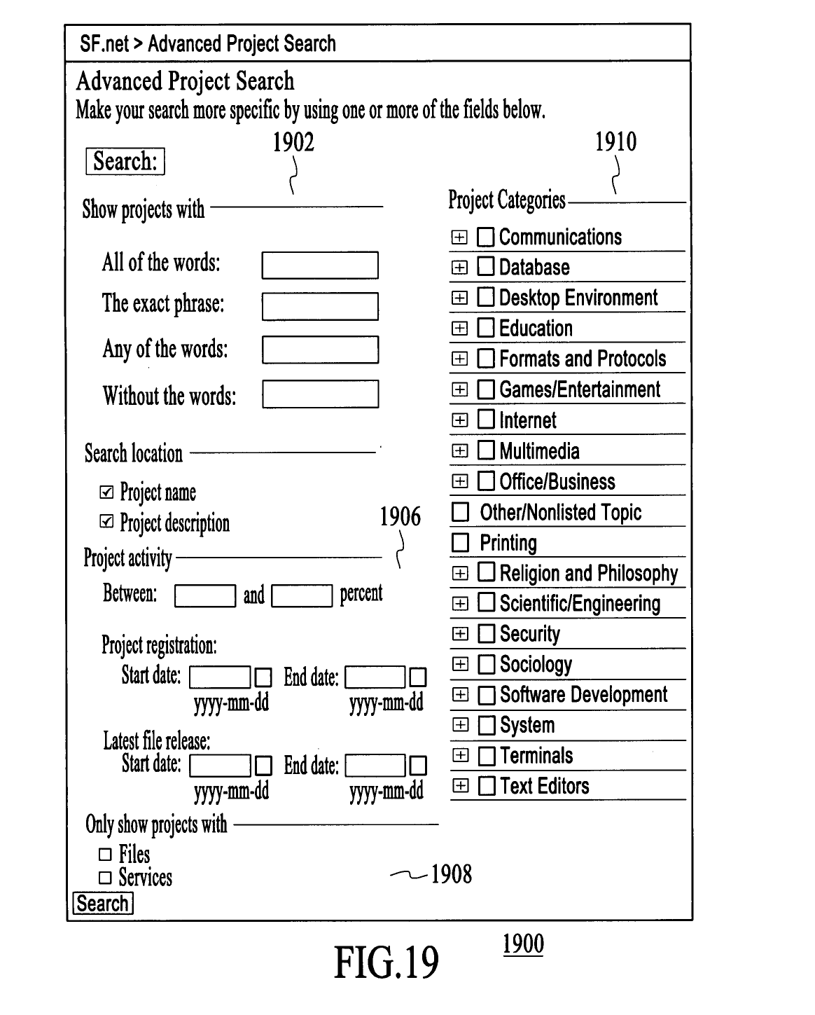

A further way in which a buyer may search for projects with or without service listings is through an advanced project search, box 1412. FIG. 19 is a web page allowing a buyer to enter an advanced project search, under an embodiment. This page allows the user to enter projects based on words used within the project description 1902, or by location 1904, or by relevant date or activity information, 1906. The command buttons 1908 allow the user to specify whether the returned projects must have services and/or files attached thereto. For convenience, a project category software map 1910 may be provided to allow the buyer to navigate through the repository to find the desired projects.

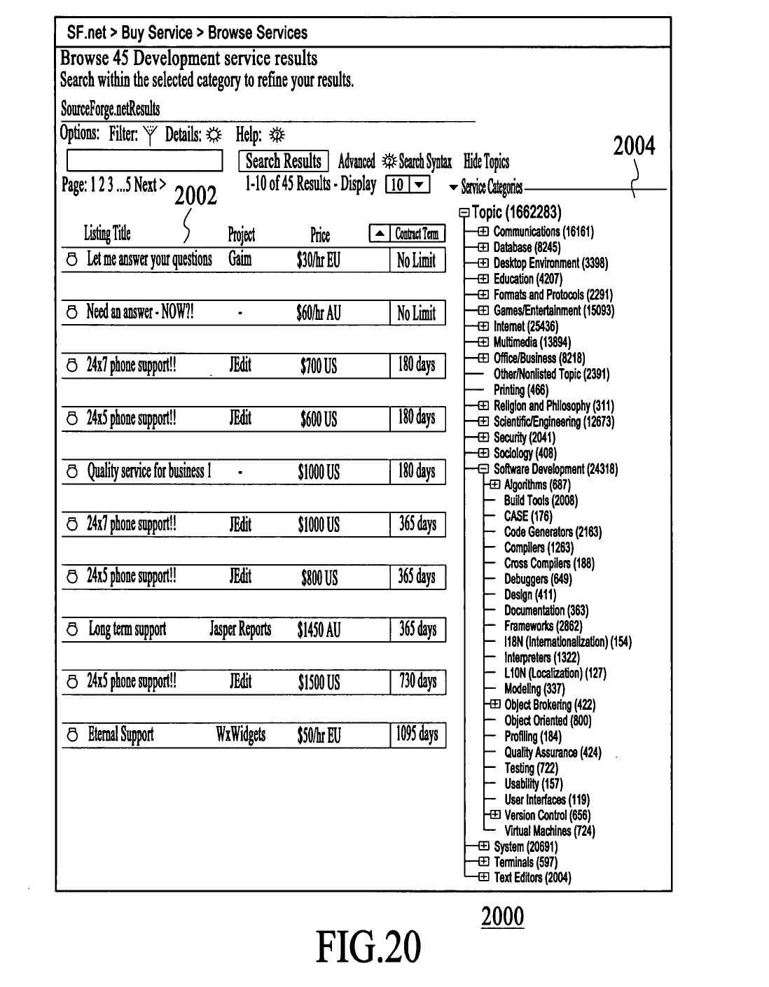

Once the buyer has searched for and found the relevant projects, the system returns a listing of projects or a link to the specific project. If the user searches for a service listing directly, such as in block 1406 and 1410, the system will return a list of possible service listings. FIG. 20 is an example web page of returned search results for an example service listing search, under an embodiment. For the example shown in web page 2000, a number of different service listings is displayed in display area 2002. Each provides a quick summary of relevant information regarding the service listing. For convenience, a service listing map 2004 may be provided to allow the buyer to navigate through the repository to find specific service listings.

### Endorsement/Rating

In one embodiment, the service listing system provides various mechanisms to allow manufacturers to endorse sellers in connection with provision of services related to a manufacture's open source projects within the system.

In one embodiment, the graphical user interface for the users can include a service tab that allows manufacturers to specify their open source project's level of involvement with the listing service. Involvement levels can include: No involvement, Full involvement, Partial involvement, and so on.

Ratings may be provided by a numerical, qualitative, or letter-grade type rating for a project or service. In one embodiment, the ratings are averaged over the number of users providing feedback, and the average grade or rate is displayed within the service listing. Alternatively, a histogram or distribution of all ratings given can be provided. If space and memory constraints allow, individual ratings and comments can be displayed as well. Similarly, a rating system is provided by the system for the services and service providers. These average or total ratings are then displayed in the service listings. In this manner, a buyer can review feedback relating directly to a service listing before selecting the service. Such a rating system can be used by the system to compile statistics related to the projects and services provided by the system. They can also be used to provide a filtering function to the search engine. For example, during a search for services related to a project, a user may specify that only service providers that meet some minimum rating criterion are to be returned in the search results.

The system can also provide forums, web logs (“blogs”), and similar text based interactive networks to allow users to post comments and engage in an online dialog to provide feedback and rating to other users.

One issue related to ratings for services, is that such items are not one time events, but are often a series of items that are delivered over a long period of time. For example, a long term service contract may extend over a long period of time and may comprise many different types of tasks during that time period. In order to attach meaningful rating to such services, the system includes a multi-part rating system in which the buyer is allowed to enter ratings at several pre-defined milestones, such as initial contact, and conclusion, as well as any defined interim events. These intermediate subratings are then combined to provide a composite or final rating. The combination process could comprise an averaging process, a weighted averaging process, or any similar method in accordance with the characteristics of the service and the time period, and definition of any milestone events.

In one embodiment, the service listing process itself includes the endorsement and rating mechanisms, whereby manufacturers and users of the services can rate the service providers and/or support products. Alternatively, these mechanisms may be included within a separate process of the system through a component that implements a rating or similar system to allow user to enter a numeric, or similar rating, or a descriptive evaluation of the service providers and projects accessed through the system.

Although embodiments have been described with reference to open source software product, it should be understood that such embodiments can also be applied to any other product or service that is distributed over the Internet or similar computer network, and can include closed source or proprietary software (object and/or source code), designs, design tools, and any other service or product that may require some form of technical support or maintenance that may be provided by the manufacturer, distributor or any third party.

Aspects of the service listing process and system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the service listing system is not intended to be exhaustive or to limit the embodiments to the precise form or instructions disclosed. While specific embodiments of, and examples for, the service listing system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the service listing system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the service listing system may be presented in certain claim forms, the inventor contemplates the various aspects of the methodology in any number of claim forms. For example, while only one aspect of the system is recited as embodied in machine-readable medium, other aspects may likewise be embodied in machine-readable medium. Accordingly, the inventor reserves the right to add additional claims after filing the application to pursue such additional claim forms for other aspects of the described systems and methods.

What is claimed is:

1. A method comprising:
hosting a plurality of open source projects in a repository embodied on one or more data stores coupled to a server computer;
providing a service listing page allowing a service provider to create a service listing describing characteristics relating to a service provided by the service provider;
associating the service listing with at least one open source project available through the repository; and
providing a search tool enabling a user to find an open source project in the repository with the associated service listing.

2. The method of claim 1 wherein the open source project comprises one or more source code modules, and wherein the repository provides access tools allowing the user to download the one or more source code modules to a client computer coupled to the server computer over a network.

3. The method of claim 2 wherein the plurality of open source projects are stored in a data store closely coupled to the server computer.

4. The method of claim 2 wherein each open source project of the plurality of open source projects comprises one or more software programs that are provided in human-readable form for download to the client computer.

5. The method of claim 4 wherein the service provided by the service provider is selected from the group consisting of: installation help, use instruction, bug fixes, updates, and adaptation to other platforms.

6. The method of claim 5 wherein the service listing describes a service that at least partially includes a product component comprising a software product available on a data store coupled to a server computer operated by the service provider.

7. The method of claim 6 wherein the service listing is associated to a specific open source project of the plurality of open source projects.

8. The method of claim 7 wherein each open source project is represented by a project listing that provides a summary description of the project, and the specific open source project includes a link to the service listing.

9. The method of claim 8 wherein the link comprises a navigation icon displayed on a graphical user interface of the client computer, the navigation icon allowing the user to locate and access the service listing over the network.

10. The method of claim 9 wherein the search tool is configured to allow the user to search for a service listing by a process selected from the group consisting of: specifying a project listing that contains a link to a service listing, specifying a service listing, and specifying a service provider that provides service listings associated with a project.

11. The method of claim 6 wherein the plurality of open source projects are categorized into a plurality of categories, and wherein the service listing is associated with a particular category of the plurality of categories.

12. The method of claim 11 wherein the service listing includes a description of a specialization of the service provider within the particular category.

13. The method of claim 12 wherein each open source project is represented by a project listing that provides a summary description of the project and an identification of the category to which the project belongs, the method further comprising: providing a link to the service listing for each open source project that is within the particular category.

14. The method of claim 13 wherein the link comprises a navigation icon displayed on a graphical user interface of the client computer, the navigation icon allowing the user to locate and access the service listing over the network.

15. The method of claim 14 wherein the search tool is configured to allow the user to search for a service listing by a process selected from the group consisting of: specifying a project listing that contains a link to a service listing, specifying a service listing, specifying a service provider that provides service listings associated with a project, and specifying a category of project.

16. The method of claim 1 further comprising providing a rating component configured to allow a manufacturer of the open source project to rate a service provided by the service provider and to allow a user of the service to rate the service.

17. The method of claim 16 wherein the rating component is configured to generate a composite rating for a service that is provided over a period of time, the rating component defining a plurality of service milestones, allowing a user to enter an individual rating for each milestone of the plurality of service milestones, and combining each individual rating by a defined formula to obtain the composite rating.

18. The method of claim 17 wherein the defined formula comprises one of a simple average, or a weighted average with each milestone assigned a weighting value relative to the other milestones of the plurality of service milestones.

19. A method comprising:
storing a plurality of software products in a first data store;
storing a product listing for each of the software products in the first data store, each product listing describing a summary of a respective software product;
storing a plurality of service products in a second data store, each service product providing an element of support to at least one software product of the plurality of software products;
allowing a seller to create and store a service listing on a client computer, each service listing describing a summary of a respective service product;
linking at least one service listing to a product listing based on applicability of the corresponding service listing to the product listing; and
allowing a user to locate a service listing based on a search of at least one of the product listing or the service listing.

20. The method of claim 19 wherein the software products comprises components of an open source project.

21. The method of claim 20 wherein the open source project is store in a data store comprising one of the group consisting of: a database maintained by a manufacturer of the open source project, and a database maintained by a system administrator of the first data store, and a database maintained by a system administrator of the second data store.

22. The method of claim 19 wherein the service listing is linked to a specific open source project by a reference to an identifier of the specific open source project.

23. The method of claim 22 wherein the reference comprises a navigation icon displayed on a graphical user interface of a client computer operated by a user of the open source project, the navigation icon allowing the user to locate and access the service listing over the network.

24. The method of claim 23 wherein the service listing provides information allowing the user to purchase services from a provider of the services.

25. The method of claim 24 further comprising providing a search engine that is configured to allow the user to search for a service listing by a process selected from the group consisting of: specifying a project listing that contains a link to a service listing, specifying a service listing, and specifying a service provider that provides service listings associated with a project.

26. The method of claim 19 wherein the plurality of software products are categorized into a plurality of categories, and wherein the service listing is associated with a particular category of the plurality of categories.

27. The method of claim 26 wherein the service listing includes a description of a specialization of the service provider within the particular category.

28. The method of claim 27 wherein each software product is represented by a product listing that provides a summary description of the product and an identification of the category to which the product belongs, the method further comprising: providing a link to the service listing for each software product that is within the particular category.

29. The method of claim 28 further comprising providing a search engine that is configured to allow the user to search for a service listing by a process selected from the group consisting of: specifying a project listing that contains a link to a service listing, specifying a service listing, specifying a service provider that provides service listings associated with a project, and specifying a category of software product.

30. A system comprising:
a server computer operated by a system administrator;
a repository coupled to the server computer, and comprising one or more data stores hosting a plurality of open source projects;
a network link coupling the server computer to a first client computer operated by a user of an open source project of the plurality of open source projects, and to a second client computer operated by a provider of support services associated with the open source project; wherein the server computer includes:
a service module providing a service listing page allowing the service provider to create a service listing describing characteristics relating to the support provided by the service provider,
a product module providing a product listing page describing characteristics related to the open source project,
a linking module associating the service listing with the product listing page, and
an integrated search engine enabling the user to find an open source project in the repository with the associated service listing.

31. The system of claim 30 wherein the open source project comprises one or more source code modules, and wherein the repository provides access tools allowing the user to download the one or more source code modules to the first client computer over the network.

32. The system of claim 31 wherein the open source project comprises one or more software programs that are provided in human-readable form for download to the client computer.

33. The system of claim 32 wherein the support provided by the provider is selected from the group consisting of: installation help, use instruction, bug fixes, updates, and adaptation.

34. The system of claim 33 wherein the service listing describes a service that at least partially includes a product component comprising a software product available on a data store coupled to the second client computer.

35. The system of claim 30 wherein the service listing is associated to a specific open source project.

36. The system of claim 30 wherein the open source projects are categorized into a plurality of categories, and wherein the service listing is associated with a particular category of the plurality of categories.

37. The system of claim 31 wherein the service listing includes a description of a specialization of the service provider within the particular category.
